(19) United States
(12) Patent Application Publication
(10) Pub. No.: US 2009/0287527 A1
(43) Pub. Date: Nov. 19, 2009

(54) Device for communicating orders for transportation, vehicle-base communication device, communication system and method

(75) Inventors: Dieter Kolb, Germering (DE); Eva Spies, Reinsfeld (DE)

Correspondence Address: HARNESS, DICKEY & PIERCE, P.L.C., P.O.BOX 8910, RESTON, VA, 20195, US

(73) Assignee: SIEMENS AKTIENGESELLSCHAFT

(21) Appl. No.: 12/285,853

(22) Filed: Oct. 15, 2008

(30) Foreign Application Priority Data
Oct. 19, 2007 (DE) 10 2007 050 155.4

(51) Int. Cl. G06Q 10/00; G01C 21/26

(52) U.S. Cl. 705/9; 705/1; 701/204; 701/207

(57) ABSTRACT

A communication system is disclosed for transportation orders. It at least one embodiment, it includes a central communication device, with a memory for recording order specifications, with a transceiver unit for receiving vehicle information and with an assignment unit which is embodied for assigning orders to vehicles on the basis of the vehicle information and the order specifications, with an order which can be assigned to one or more vehicles, able to be sent via the transceiver unit to the vehicle or the vehicles and further including at least one vehicle-based communication device, with a transceiver unit for transmission of vehicle information and for receiving transportation orders, with the communication device being connected or able to be connected to each communication device for communicating communication orders via a respective communication link.

### PRIORITY STATEMENT

The present application hereby claims priority under 35 U.S.C. §119 on German patent application number DE 10 2007 050 155.4 filed Oct. 19, 2007, the entire contents of which is hereby incorporated herein by reference.

### FIELD

Embodiments of the invention generally relate to a device for communicating orders for transportation, to a vehicle-based communication device, to a system for communicating transportation orders and/or to an associated switching method.

### BACKGROUND

In cities with a number of taxi companies, customer orders for taxis are usually received by one or more taxi dispatch centers and can then be distributed to the individual taxis of taxi drivers of the taxi companies. The taxi customer dials a taxi number, specifies both the time and the place at which the taxi is required, sometimes also specifies additional criteria such as a people-carrier taxi, non-smoking taxi, credit card taxi etc. The taxi dispatch center accepts the request from the customer and passes it on to the taxis of the independent taxi operator. The taxi confirms that the criteria of the order are fulfilled. Taxis are ordered by preference according to specifications provided by the customer. After an order has been accepted by a taxi the order is confirmed by the dispatch center and is blocked for all other taxis. The customer then receives a confirmation from the dispatch center for his request if required.

The taxi or the taxi driver respectively operates either independently or within a taxi operator. The customer in this case is the taxi customer, the contractor is the taxi. Thus, the taxi dispatch center merely takes on the function of an agent to communicate the orders from customers to the taxi operator. For this agency function the taxis normally pay a fixed monthly amount. In larger towns there are generally several taxi dispatch centers. As a rule taxis only work in conjunction with one taxi dispatch center.

Previously two different approaches existed for resolving the task of communication of orders by the taxi dispatch center. The most widespread method is the taxi radio. In such cases the taxi customer calls a taxi number and gives his order and the order specifications to the taxi dispatch center. The taxi dispatch center passes on the order to all taxis which are on a specific radio channel. The taxis confirm the order by independently evaluating and selecting the order. Taxi radio is not a protected method. There are numerous different providers.

A second method is a GPS (Global Positioning System)-based method from Heedfeld (http://www.heedfeld.DE). In this system, at each point in time the precise position of the taxis assigned to a taxi dispatch center is determined. Here again the taxi customer dials a taxi number and gives his order and the order specification to the taxi dispatch center. The taxi dispatch center passes on the orders to the taxi which is closest to the position of the taxi customer. The taxi confirms the order. The taxi dispatch center again confirms the taxi customer's order. This means that there is one central computer which monitors the position of all taxis. The person receiving the telephone order for the taxi looks at the position of all taxis and allocates the orders accordingly.

The international patent application 01/72078 A1 discloses a method for ordering taxis via a mobile telecommunication system. In this case the taxis are equipped with a mobile telephone. Within the mobile telecommunication system a position management is undertaken in order to establish a connection to each mobile telephone. The taxi dispatch center receives a digital order from a customer telephone and on the basis of this order establishes the order address of the taxi and on the basis of the stated address the taxi group. Without setting up a voice connection the taxi dispatch center sends a call to the taxis of the stated group. The determination of those taxis which are indeed the vicinity of the order address is undertaken by a server which determines and tracks the position of the mobile telephones as precisely as possible. The accuracy of this method is however subject to the technical limits of a cell-based mobile telephone network and demands significant server-side outlay to establish positions of the taxis within the cells.

### SUMMARY

In at least one embodiment of the present invention, a system is created for communicating transportation orders which has a simple structure, is fast and reliable and also flexible and cost-effective.

In at least one embodiment, a communication device includes a memory for recording orders, with a transceiver unit for receiving vehicle information under with an assignment unit which is embodied for assigning orders to vehicles on the basis of the vehicle information and order specifications, with a respective order which can be assigned to one or more vehicles being able to be sent via the transceiver unit to the vehicle or vehicles.

A significant point of the invention lies in this case in current vehicle information relating for example to a position, an operating state (waiting or en route, if en route occupied, partly occupied or empty, minibus, van or limousine; non-smoker- or smoker taxi; credit card- or cash-payment taxi etc.) always being available to the device. The position specification of the vehicle can in such cases be based on a GPS position and/or a route position coupled in according to direction of travel and speed of which the coordinates are transferred to the device. The communication device itself is relieved in such cases of the task of determining the position and merely has to store the received data and include it for further processing, i.e. for assignment of a customer order. This means that an especially precise and fast, therefore reliable communication of a vehicle is possible which is also able to be transferred fully automatically to the appropriate vehicle.

Basically it is possible to specify an order for transportation through comprehensive specifications. An especially simple specification includes, however, at least specifying a place and a time. This makes the communication of the order easier for the customer if there is no absolute requirement to give further details. These could for example additionally relate to a desired arrival destination, an arrival time, a route, transport of an especially large volume of luggage or heavy luggage, of small children with a baby seat or similar.

It is of advantage in such cases for the location to be specified by its geographical coordinates. This allows an especially precise selection and thus control of the vehicles. These also already have fixed built-in devices such as navigation/route planning systems and/or GPS receivers which allow their exact coordinates to be determined.

As already previously indicated, a transportation order can be specified in a wide diversity of ways. However the preference is for a type of vehicle (minibus, van, limousine) and/or payment (credit card, cash) to be specified. As regards the number of items of luggage and the availability of cash these are especially important criteria for the selection of a desired vehicle.

In at least one embodiment, a vehicle-based communication device includes a memory for recording vehicle information and a transceiver unit for sending his vehicle information and for receiving orders.

A significant point of at least one embodiment of the invention lies in this case in the fact that the vehicle information is recorded where it is at its most up-to-date, namely directly at the vehicle. The transfer of the respective current information to a central communication system means for example that position details do not have to be artificially updated or suppositions made about them. The load is thereby relieved on the central system and a clear separation of functions between the components is possible. This allows a communication system to be structured in an especially simple and reliable manner.

Basically the vehicle information can include all items which are needed for reconciliation with a transportation order as specified above. In particular the information can also include a destination and an arrival time of an ordered journey which can be included for assigning a customer order. A very high level of flexibility in communication is achieved in this way. In the simplest variant this information however includes at least one location and a load factor specification. In their orders, customers merely have to specify a location which is reconciled with the location of the vehicle and its load factor (fully-occupied, partly-occupied or empty), which makes an especially simple and fast communication possible.

In such cases the location of the vehicle is able to be determined in an especially precise and simple manner if the communication device has a location-finding component to determine a current vehicle location. This can for example consist of a GPS receiver and/or a coupling function which takes direction of travel and speed into account. An especially precise determination of the location of motor vehicles suitable for communicating a customer order is thus possible.

The successful communication of a transportation order is preferably confirmed at an input unit of the communication device which is embodied for generating an acceptance message for a transportation order to the communication device. On the one hand this signals to the customer that their order was successfully communicated, on the other hand however the order can also be blocked for other motor vehicles.

In at least one embodiment, a communication system is disclosed for transportation orders, comprising an inventive central communication system and at least one inventive vehicle-based communication device with its already mentioned advantages, with the communication system being connected or being able to make a connection to each communication device for determining transportation orders via a respective communication link.

An important point of at least one embodiment of the invention in this case lies in its simple and efficient coupling of each communication device to the communication system which allows a simple and fast communication of transportation orders.

According to at least one embodiment, there is provision in example embodiment of the system for the transceiver unit to be embodied as a GSM (Global System for Mobile Communication), GPRS (General Packet Radio Service)-, UMTS (Universal Mobile Telecommunications System) or WLAN (Wireless Local Area Network) interface. This ensures a high level of flexibility in the connection a diversity of communication devices in the motor vehicles, such as mobile telephones, PDAs (Personal Digital Assistant), laptops or similar.

The acceptance and entry of customer orders in the communication system described above can basically be undertaken by a person in a dispatch center. For fully-automatic handling of customer orders it is however preferable for this to be done via a telecommunication terminal which is embodied for entry of a transportation order and for sending this transportation order to the communication device. Such a device can for example be a mobile telephone, a PDA or an Internet-enabled laptop or PC. The communication thus created is especially fast and cost-effective.

It is preferable in such cases for the telecommunication terminal to be embodied for receiving and displaying a confirmation message about the successful communication of an order for transportation. This feedback gives customers reassurance that their orders were not only accepted but were also communicated.

This reassurance is increased by the confirmation message including an estimated arrival time and/or a current location of the communicated motor vehicle. The customer can adjust accordingly to the transportation whereby the vehicle is possibly at the desired location even earlier, but can also be delayed for example by traffic congestion, accidents or similar.

An especially precise determination of the vehicle location is guaranteed by the telecommunication terminal having a location-finding component which interacts with a satellite-based global positioning system. This is not just important for the exact assignment of customer orders to vehicles. It can also be of importance for the customer, who for example wishes to inquire via his telecommunication terminal about the current location of an ordered vehicle.

Basically the communication system outlined is suitable for all types of driving or transportation orders, the object of which is the transport of persons or goods, for example by car, airplane, ship or train. It is especially preferred however if the communication system is used for ordering taxis, since it is precisely here that its speed and flexibility counts.

In at least one embodiment, a communication method is disclosed with an inventive central communication device and an least one inventive vehicle-based communication device for which orders to the communication device are recorded and with the inclusion of received vehicle information and of recorded order specifications are assigned to one or more vehicles and are sent to the communication device of these vehicles.

A significant point of at least one embodiment of the invention lies in this case in the simple implementation of the method with the advantages already outlined.

Accordingly, there is provision in an advantageous embodiment for a respective order for transportation to contain a time specification and at a predetermined interval before the arrival of the specified time to be assigned to one or more vehicles and to be sent to this vehicle or to these vehicles. By selecting a short time interval it is ensured that an order is only assigned to vehicles which are actually in the immediate vicinity of the specified location. Conversely however by selecting a large time interval individual vehicles can be given the possibility of predictive planning to accept further orders. Both options can be selected as a function of the actual order situation.

A further advantage arises if a respective transportation order contains a location specification and this order is only assigned to one or to a number of vehicles and is sent to this vehicle or to these vehicles which is or are located within a pre-defined radius around this location. This means that the number of vehicles concerned is restricted to those which promise to fulfill the order especially quickly.

It is also of advantage for the at least one communication device of a vehicle within the predetermined radius to be able to send an acceptance message for the communicated transportation order to the communication device. The order in this case must not be visible to vehicles outside this radius. After entry of the acceptance message the order can also no longer be visible for the vehicles located within this radius or can be identified as placed.

If within a predetermined period no acceptance message for the communicated transportation order arrives, the transportation order is preferably assigned to one or more vehicles and to the vehicle or to the vehicles which are located within an expanded radius around the location. This makes reliable communication of the customer order even with lower vehicle density possible.

The circle is expanded in such cases preferably until such time as an acceptance message for the communicated transportation order arrives at the communication device. This means that a search is not deliberately aborted for example on reaching a specific radius, but communication is forced. Thus the reliable communication of a customer order is ensured independently of the vehicle density.

After arrival of an acceptance message for a communicated transportation order a confirmation message is preferably sent by the communication device to the communication device of the vehicle which has reported acceptance. The reliability of the communication is also increased in this way this since driver-side uncertainties are excluded as to whether an acceptance has actually been registered and the order thus counts as allocated.

In the case of a number of (competing) acceptance messages for a respective transportation order it is of advantage for a confirmation message to be sent from the communication device to the communication device of the vehicle which first reported the acceptance. In this way driver-side mistakes about the actual allocation of an order are excluded.

To make it possible for the respective drivers to have a prior overview of the actual locations of their vehicles it is preferred for their position to be retrieved at the communication device and displayed at a communication device. They can then decide for example to drive into an area of lower taxi density in order to obtain orders. In this way transport capacities of the communication system are used efficiently.

If a transportation order is entered at a mobile telecommunication terminal and sent to the communication device it is preferable for a confirmation message about the successful transfer of the order to be sent from the device to the terminal. The customer is thus also given an assurance that their order has been successfully processed.

The customer is especially flexible in the placement of the order if a transportation order can be made by a keyboard entry, by voice recognition and/or by position determination via GPS.

For communication with the communication device a fixed network or mobile telephone, a PDA or laptop is preferably used since these terminals are especially widespread and allow simple linkage to the device.

### BRIEF DESCRIPTION OF THE DRAWINGS

The present invention is explained below in greater detail on the basis of an example embodiment which refers to the enclosed figures. The same parts or parts with the same function are labeled with the same reference numbers. The figures are as follows:

FIG. 1 a communication scenario for motor vehicles with a semi-automated inventive communication system;

FIG. 2 a communication scenario for motor vehicles with a fully-automated inventive communication system;

FIG. 3 a schematic diagram of major functions of the central communication device of FIG. 2, and

FIG. 4 a schematic diagram of major functions of the vehicle based communication device of FIGS. 1 and 2.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath”, other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

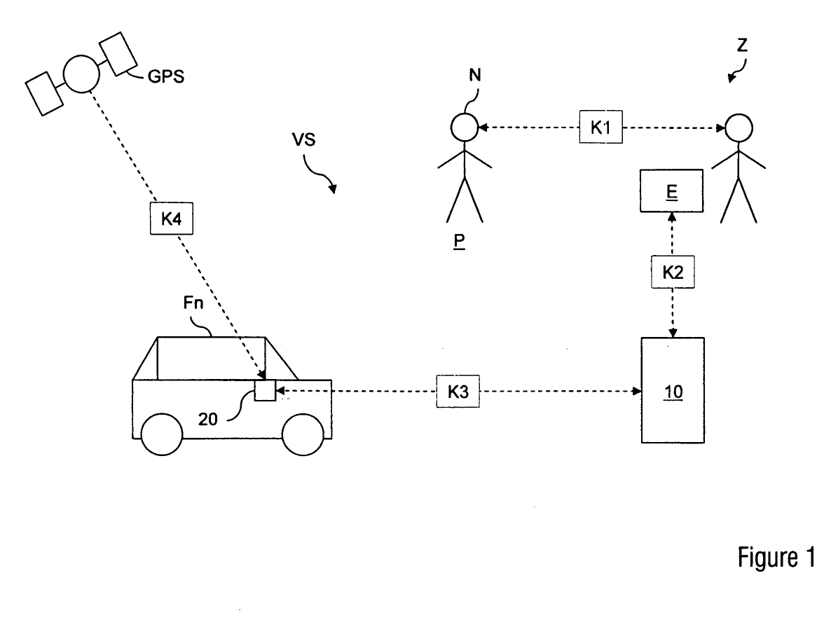

FIG. 1 shows a communication scenario for motor vehicles F1 . . . Fn, here of a taxi Fn, with a semi-automated inventive data transmission system VS, which comprises a central communication device 10 and at least a vehicle-based communication device 20.

In the example presented here the communication system VS is implemented on the basis of the ‘Digital Graffiti system from Siemens. Digital Graffiti is a location-based service, with the aid of which information I assigned to a location and is communicated in time and space to a precisely specified group of vehicles. The vehicles can be specified on the basis of filter criteria. Basic technical elements of a typical digital graffiti system are a server which corresponds here to the communication system 10 and clients, which correspond here to the at least one communication device 20. The clients 20 in such cases have a location-finding component such as for example a receiver here, which obtains its position signals over a communication link K4 from a satellite global positioning system GPS. In addition the communication system VS has a communication interface between server 10 and clients 20 based on GPRS, UMTS or WLAN.

The communication process for the taxis F1 . . . Fn is based on a number of process steps. Initially the order is specified in which a user N, i.e. the taxi customer in this case, specifies a time and a place P at which he needs a taxi. Under some circumstances additional criteria for the order are also specified. The order is specified over a communication link K1 to a switching or taxi dispatch center Z, which registers this order via an input unit E and a communication link K2 to the server 10. The server 10 subsequently determines a taxi as the contractor which corresponds to the order specifications. The order is directed to the taxi over a communication link K3. If the taxi accepts the order, all other potential contractors are excluded from this order. The successful switching of the order is confirmed by the taxi dispatch center Z at the same time to the customer and also to the contractor.

An embodiment of the proposed invention is based in this case on two capacity stages. With the first capacity stage of the system VS described in FIG. 1 the switching process occurs semi-automatically, i.e. via a dispatch center Z. In the final capacity stage of the system VS all process steps for dispatching a taxi Fn are undertaken fully automatically.

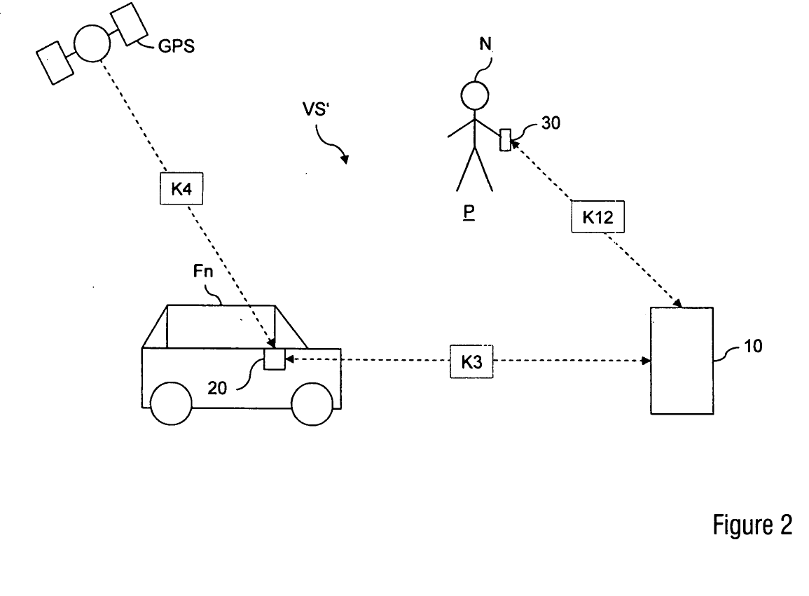

FIG. 2 shows a communication scenario for motor vehicles F1 . . . Fn with a fully-automated inventive embodiment of the communication system VS′. In this final capacity stage of the system VS the customer N orders a taxi Fn with a telecommunication terminal 30 for a specific time at a specific place P. The terminal 30 can be a landline telephone, a mobile telephone (cellphone), a PDA or similar. The place P and of the time can be specified in different ways. On the one hand by entries on the keyboard of the telephone 30, comparable with an SMS input, on the other by voice input in conjunction with a corresponding voice recognition system, by position finding using GPS, if the taxi is to be dispatched to the customer's current location, by marking the corresponding position in a map shown on the terminal 30 or by any given combination of these techniques. In addition the customer can specify any special requirements in this way.

The order is sent from the terminal 30 via a communication channel or a communication link K12 to the server 10. The link K12 can involve a fixed network telephone line or a mobile radio connection such as GSM, GPRS, UMTS or similar. In the server 10 the order is stored in the form of a graffito in accordance with the specification of the customer N. The graffito is virtually assigned to the place P at which the customer N has ordered the taxi. The place P is described by its geographical coordinates.

The taxis F1 . . . Fn constantly determine their current position, direction of travel and speed, For example with the aid of the satellite-based system GPS. Via a communication link K3 they transmit this data as well as the information about whether the taxi is free or occupied, to the server 10. A mobile radio connection such as GSM, GPRS, UMTS or similar, taxi radio, WLAN or another wireless communication technology can be used as the communication link K3.

The server 10 thus has available to it at all times the information about the current locations of all free taxis. If an order graffito arrives at the server 10 a timer is used to make the graffito visible in good time before the time that the order is to be executed. In addition the additional order specifications such as non-smoker taxi, credit card taxi for example etc. are used as a filter for the visibility of the graffito. The graffito is initially given a small visibility radius, so that so there are only a few free taxis in the circle that it defines. The graffito is visible to all taxis F1 . . . Fn located within the defined radius and matching the specified filter criteria. They receive the graffito in accordance with the principle of Digital Graffiti submitted via the communication link K3. The graffito is then shown on the client 20 installed in their taxi Fn.

The taxi drivers can register their interest for the order specified in the graffito through an input function. If a number of taxi drivers register their interest almost simultaneously, the server 10 determines, on the basis of the first response to arrive, the taxi which is to carry out the order. This means that the order is determined passively by the system. The order is accepted actively by the taxi driver.

The accepted order is automatically confirmed by the system VS′. Both the taxi customer N and also the tax driver who has obtained the additional information receive a confirmation. At the same moment the graffito becomes invisible. Only the customer N and the taxi driver who has received the order can still see the graffito and thus the location of the planned fare pickup. If within of a defined period no taxi driver reacts to the graffito, the radius is automatically expanded around the reference point by the system VS′. This potentially allows a larger number of taxis to see the graffito. The expansion of the radius continues until such time as a taxi has accepted the order described in the graffito.

The taxi customer N receives the information about which taxi has accepted his order. He can obtain information at any time about the location of ‘his taxi’ Fn and the estimated time of its arrival. In this way for example he can have the location displayed in a map on his terminal 30.

Thus, the determination occurs fully automatically in the final capacity stage of the system VS. Only the taxi customer N as customer has to specify the order and the taxi as contractor must confirm the order.

On request a taxi driver can have the positions of the other taxis F1 . . . Fn transmitted by the server 10 and have them displayed in a map on his client 20 installed in the taxi.

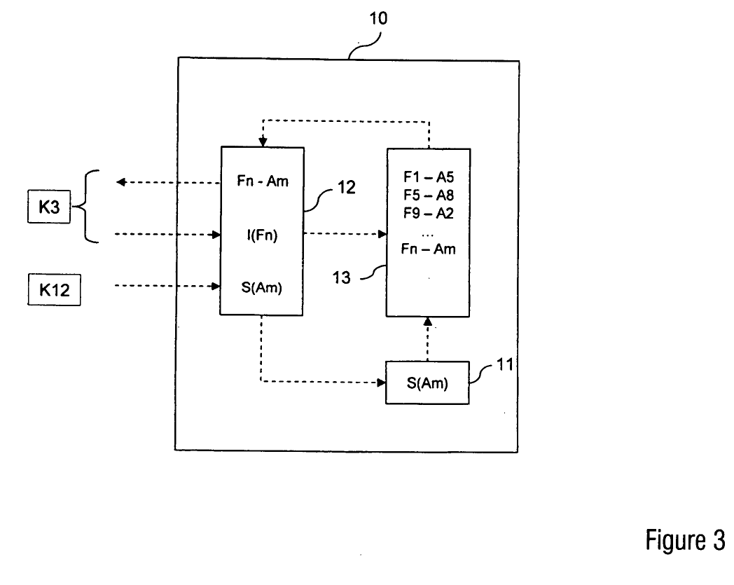

FIG. 3 shows a schematic diagram of the major functions of the central communication system 10 of FIG. 2, i.e. the communication system VS′ in its fully-automated state. The server 10 features a memory 11 for transportation orders S, a common transceiver unit 12 for recording transportation orders A1 . . . Am and an assignment unit 13 of these orders to the motor vehicles F1 . . . Fn. The order specifications S(Am) arriving via the communication link K12 are stored in the memory 11 and compared with the ongoing vehicle information I(Fn) received via the communication link K3. Taxis suitable for the respective order are informed via the communication link K3 and can accept or reject the order. In this case the order A5 for example has been assigned to the taxi F1, the order A8 to the taxi F5, the order A2 to the taxi F9 etc.

In the first capacity stage the process steps ‘issuing of the order’ and ‘acceptance of the order’ thus occur by telephone or manually between the customer N and an employee of the taxi dispatch center Z. The employee enters the order Am and the order specification S via an input unit E and a connection K12 into the system VS. Based on the order specification S the system creates a graffito which is stored in the server 10. The graffito is virtually assigned to the place P specified by the taxi customer N and corresponds here to the order specification S(Am). For this the precise GPS position of the order Am is determined by the system VS, VS′. All further process steps occur as described above for the final capacity stage, meaning the determination of the positions of the individual taxis F1 . . . Fn, the submission of the inquiries to the taxis in the form of graffiti, the acceptance of the order by the taxi driver and the confirmation of the order for the taxi driver. Only tracing the current location of ‘his taxi’ Fn is not yet possible for the taxi customer N in the first capacity stage VS. On request however he can receive a confirmation of the order acceptance in the form of an SMS.

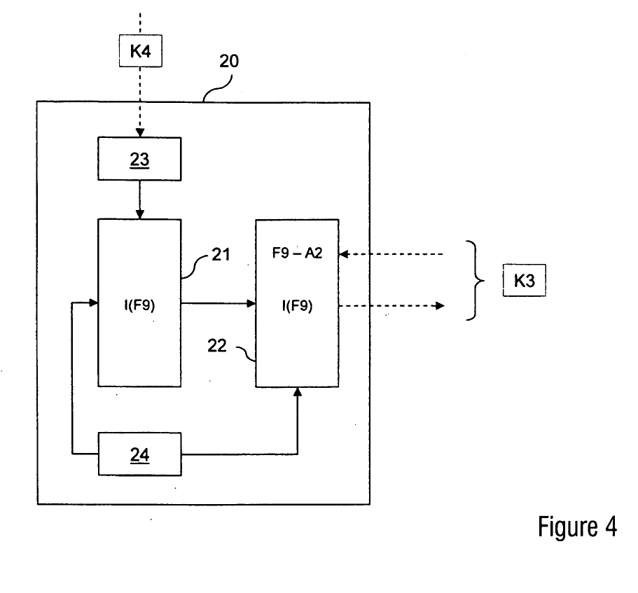

FIG. 4 shows a schematic diagram of the major functions of the vehicle-based communication device 20 of FIGS. 1 and 2. As an example for all other vehicles F1 . . . Fn these functions are to be described with reference to a device 20 built into the vehicle F9. The client 20 in this case has a memory 21 for vehicle information I of this taxi, which is sent via a transceiver unit 22 and the communication link K3 to the server 10. The vehicle information I in such cases comprises a position specification, which is obtained via a GPS localization component 23. Conversely orders Am arrive via the communication link K3 for the taxi F9. In this example it is the order A2, which is assigned to this taxi F9 by the central communication device 10 and has been transmitted, as is shown in FIG. 3. The taxi can also be reported as free or busy via an input unit 24 and the transportation order A2 arriving via the transceiver unit 22 can be confirmed.

By contrast with the existing technologies mentioned, an embodiment of the invention thus has significant innovations. The conventional taxi radio suffers in particular from capacity bottlenecks. While a number of orders can be issued and accepted in parallel, the order can only be communicated via one common taxi radio channel. At any given point in time only one order can ever be communicated through the taxi radio channel. In large cities therefore a number of taxi dispatch centers exist in parallel, communicating on different radio channels. In addition large cities are divided up into districts for which different radio channels will be used in each case.

The embodiment of the proposed invention discussed above does not have any capacity bottlenecks. In particular the orders can be communicated in parallel.

In the GPS-based system from Heedfeld the taxi driver is issued with an order by the dispatch center Z in a pushbased service in accordance with his current position and the position of the customer P. The driver is not linked into the order allocation process.

In the embodiment of the invention described here the customer N receives the information as to which taxi Fn has accepted his order. He can communicate with the taxi Fn, agree any possible changes and he can inquire at any time about its current position and estimated time or arrival and have this displayed to him on a map.

The taxi driver on the other hand can see the positions of the other free taxis in his environment and subsequently decide whether to drive to another area occupied by fewer taxis. Likewise he can view the taxi density in another destination area.

The system VS, VS′ proposed here knows the positions of the individual taxis F1 . . . Fn. It can of course recognize the areas in which the taxi density is currently too low and transmit this information to taxis, which can then decide to drive into this area and to wait for customers there.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A communication device for transportation orders, comprising:
a memory to record orders;
a transceiver unit to receive vehicle information; and
an assignment unit, embodied to assign orders to vehicles on the basis of vehicle information and order specifications, with a respective order, assignable to one or more vehicles, being to sendable to the one or more vehicles via the transceiver unit.

2. The communication device as claimed in claim 1, wherein a transportation order is specified by at least one position and one time specification.

3. The communication device as claimed in claim 2, wherein the position is specified through its geographical coordinates.

4. The communication device as claimed in claim 1, wherein a transportation order is specified through at least one of a vehicle and mode of payment.

5. A vehicle-based communication device, comprising:
a memory to record vehicle information; and
a transceiver unit to transmit the recorded vehicle information and to receive transportation orders.

6. The communication device as claimed in claim 5, wherein the vehicle information comprises at least one position and one load factor specification.

7. The communication device as claimed in claim 5, further comprising a location finding component to determine a current location of the vehicle.

8. The communication device as claimed in claim 5, further comprising an input unit, embodied to create an acceptance message for a transportation order to a communication device.

9. A communication system for transportation orders, comprising:
a central communication device as claimed in claim 1; and
at least one vehicle-based communication device including a memory to record vehicle information and a transceiver unit to transmit the recorded vehicle information and to receive transportation orders, the central communication device being at least one of connected and able to be connected to each at least one vehicle-based communication device to communicate transportation orders via a respective communication link.

10. The communication system as claimed in claim 9, wherein the transceiver unit is embodied as a GSM, GPRS, UMTS or WLAN interface.

11. The communication system as claimed in claim 10, further comprising a telecommunication terminal, embodied to enter a transportation order and to send the transportation order to the communication system.

12. The communication system as claimed in claim 11, wherein the telecommunication terminal is embodied to receive and display a confirmation message about a successful communication of a transportation order.

13. The communication system as claimed in claim 12, wherein the confirmation message includes at least one of an estimated time of arrival and a current location of the dispatched vehicle.

14. The communication system as claimed in claim 11, wherein the telecommunication terminal has a location-finding component which interoperates with a satellite-based global positioning system.

15. A method comprising:
using a communication system as claimed in claim 10 for ordering taxis.

16. A method for communicating transportation orders within a system including a central communication device and at least one vehicle-based communication device, the method comprising:
recording orders to the communication device; and
assigning the inclusion of received vehicle information and of recorded order specifications to one or more vehicles; and
sending the assigned information to the communication device of the one or more vehicles.

17. A communication method as claimed in claim 16, wherein a respective transportation order contains a time specification, and at an interval before arrival of the specified time is assigned to one or more vehicles and sent to the one or more vehicles.

18. The communication method as claimed in claim 16, wherein a respective transportation order contains a position specification, and the respective transportation order is only assigned to one or more vehicles and is sent to the one or more vehicles located within a radius around the position.

19. The communication method as claimed in claim 18, wherein an acceptance message can be sent to the communication system from the at least one communication device of a vehicle within the radius for the transferred transportation order.

20. The communication method as claimed in claim 19, wherein, if no acceptance message for the communicated transportation order arrives within a time period, this transportation order is assigned to one or more motor vehicles and is sent to the one or more vehicles within an expanded radius around the position.

21. The communication method as claimed in claim 20, wherein the radius continues to be expanded until such time as an acceptance message for the communicated transportation order arrives at the communication system.

22. The communication method as claimed in claim 19, wherein, after arrival of an acceptance message for a transferred transportation order by the communication system, a confirmation message is sent to the communication device of the vehicle which sends the acceptance.

23. The communication method as claimed in claim 19, wherein, in the case of a number of acceptance messages for a respective transportation order from the communication device, a confirmation message is sent to the communication device of the vehicle which sent the first acceptance.

24. The communication method as claimed in claim 16, wherein the position of vehicles is retrieved at the communication system and displayed at a communication device.

25. The communication method as claimed in claim 16, wherein a transportation order is entered at a mobile telecommunication terminal and sent to the communication system, and a confirmation message about the successful communication of the order is sent from the device to the terminal.

26. The communication method as claimed in claim 25, wherein a transportation order is made at least one of by keyboard entry, by voice recognition, through position marking on a map and through positioning using GPS.

27. A method, comprising:
using at least one of a landline or mobile telephone, a PDA and a laptop for communication with a communication system in accordance with claim 9.

28. The communication device as claimed in claim 6, further comprising a location finding component to determine a current location of the vehicle.

29. The communication device as claimed in claim 6, further comprising an input unit, embodied to create an acceptance message for a transportation order to a communication device.

30. The communication device as claimed in claim 28, further comprising an input unit, embodied to create an acceptance message for a transportation order to a communication device.
